(19) United States
(12) Patent Application Publication
(10) Pub. No.: US 2013/0187754 A1
(43) Pub. Date: Jul. 25, 2013

(54) INFORMATION PROCESSING METHOD AND ELECTRONIC DEVICE

(71) Applicants: Beijing Lenovo Software Ltd, Beijing (CN); Lenovo (Beijing) Co., Ltd., Beijing (CN)

(72) Inventor: Dayong Gan, Beijing (CN)

(73) Assignees: Lenovo (Beijing) Co., Ltd., Beijing (CN); Beijing Lenovo Software Ltd, Beijing (CN)

(21) Appl. No.: 13/739,383

(22) Filed: Jan. 11, 2013

(30) Foreign Application Priority Data
Jan. 19, 2012 (CN) 201210017714.4

(51) Int. Cl. G05B 1/00

(52) U.S. Cl. CPC G05B 1/00
USPC 340/5.52

(57) ABSTRACT

An electronic device includes a structural component and a first sensor, the structural component wears the electronic device onto a body of a user, and the first sensor is provided on the structural component and located at a first position contacting with a body of the user. The method includes: acquiring a first physiological parameter of the user by the first sensor, when the electronic device is worn onto the body of the user, in which the first physiological parameter determines whether the electronic device is to be used by the user; determining whether the electronic device is to be used by the user based on the first physiological parameter to generate a determined result; and generating a first execution instruction in the case that the determined result indicates that the electronic device is to be used by the user.

### FIELD OF THE INVENTION

This invention relates to the technique field of electronics and communication, and particularly to an information processing method and electronic device.

### BACKGROUND OF THE INVENTION

At present, a glass product plays an important role in our daily life. For Example, the people with a myopia or a hyperopia needs to wear a glass for myopia or a glass for hyperopia, and sometimes, sunglass needs to be wore to prevent eyes from the harm of the burning sun.

Meanwhile, with the popularization of a 3D technique and an increasing requirement of the life quality of the people, a product related to the 3D technique, such as a 3D glass, becomes more and more popular. A user can feel more fun and more powerful visual impact when wearing the 3D glass to watch a 3D movie. Therefore, nowadays most of movies played in a cinema need to be watched by wearing the 3D glass. Furthermore, a 3D TV is also applied to a family now, and thus the 3D glass will be a part of the daily life of the user for a long time in the future.

However, when an existing glass product, such as a glass for myopia, a glass for hyperopia and the 3D glass, is worn by the user, the glass can function correspondingly. For Example, the glass for myopia can only function to see the object at distant clearly, and the 3D glass can only function to watch a movie better.

In considering a technical solution of the invention, at least the following technical problems have been found.

When an existing glass product is worn by the user, a function or state of the glass product can not be adjusted according to the requirement of the user or according to an environment automatically, and the glass product can not communicate with other devices and control other devices.

### SUMMARY OF THE INVENTION

An information processing method and electronic device is provided according to the invention, for solving the following problems in the prior art: when an existing glass product is worn by a user, a function or state of the existing glass product can not be adjusted according to a requirement of the user or according to an environment automatically, and the existing glass product can not communicate with other devices and control other devices.

In an aspect, a technical solution is provided according to a first embodiment of the invention.

An information processing method applied to an electronic device, the electronic device including a structural component and a first sensor, the structural component being adapted to wear the electronic device onto a body of a user, and the first sensor being provided on the structural component and located at a first position of the structural component contacting with the body of the user, in which the method includes:

acquiring a first physiological parameter by the first sensor in the case that the electronic device is worn onto the body of the user, the first physiological parameter being adapted to determine whether the electronic device is to be used by the user;

determining whether the electronic device is to be used by the user based on the first physiological parameter, so as to generate a determined result;

generating a first execution instruction in the case that the determined result indicates that the electronic device is to be used by the user; and

executing the first execution instruction to switch the electronic device from a first state to a second state, wherein the first state is different from the second state.

Optionally, after determining whether the electronic device is to be used by the user, the method further includes:

generating a second execution instruction in the case that the determined result indicates that the electronic device is not to be used by the user; and

keeping the electronic device in the first state according to the second execution instruction.

Optionally, the electronic device is a glass-type electronic device, and the structural component is a glass frame.

Optionally, the electronic device further includes a second sensor, and the second sensor is provided at a second position which is located at a nose pad of the glass frame of the glass-type electronic device; and the first sensor is provided at the first position which is located at a glass leg of the glass-type electronic device and contacts with the body of the user.

Optionally, the method further includes acquiring a second physiological parameter of the user by the second sensor.

Optionally, the step of determining whether the electronic device is to be used by the user, so as to generate a determined result includes:

determining whether there are both the first physiological parameter and the second physiological parameter at the same time, so as to generate the determined result for indicating whether there are both the first physiological parameter and the second physiological parameter at the same time.

Optionally, in the case that the determined result indicates that there are both the first physiological parameter and the second physiological parameter at the same time, the first execution instruction includes a startup instruction or a function actuation instruction, and the executing the first execution instruction to switch the electronic device from the first state to the second state includes:

executing the startup instruction to switch the electronic device from a power-off state into a startup state; or

executing the function actuation instruction to switch a 3D function of the glass-type electronic device from an off state to an on state.

Optionally, after determining whether the electronic device is to be used by the user so as to generate a determined result, the method further includes:

generating a third execution instruction, in the case that the determined result indicates that there are the first physiological parameter and the second physiological parameter at the same time, in which the third execution instruction is executed by the first electronic device connected with the glass-type electronic device and is adapted to switch the first electronic device from a third state to a fourth state, and the third state is different from the fourth state.

Optionally, the electronic device further includes a Bluetooth headphone, and the structural component is a headphone frame.

Optionally, the electronic device further includes a third sensor provided at a third position of the Bluetooth headphone contacting with the body of the user.

In the other aspect, the following technical solutions is provided according to a second embodiment of the invention:

an electronic device, including:

a structural component adapted to wear an electronic device onto a body of a user;

a first sensor provided on the structural component and located at a first position of the structural component contacting with the body of the user, and adapted to acquire a first physiological parameter of the user corresponding to the electronic device; and

a processor connected with the first sensor, and adapted to receive the first physiological parameter, determine whether the electronic device is to be used by the user based on the first physiological parameter, and generate a first execution instruction in the case that the electronic device is to be used by the user, in which the first execution instruction is adapted to switch the electronic device from a first state to a second state, and the first state is different from the second state.

Optionally, the processor is further adapted to generate a second execution instruction in the case that the electronic device is not to be used by the user, and the second execution instruction is adapted to keep the electronic device in the first state.

Optionally, the electronic device is a glass-type electronic device, and the structural component is a glass frame.

Optionally, the electronic device further includes:

a second sensor provided on a second position which is located at a nose pad of the glass frame of the glass-type electronic device, and adapted to acquire a second physiological parameter of the user.

Optionally, the electronic device further includes a Bluetooth headphone, and the structural component is a headphone frame.

Optionally, the electronic device further includes a third sensor provided at a third position of the Bluetooth headphone contacting with the body of the user.

Optionally, the processor is adapted to determine whether there are both the first physiological parameter and the second physiological parameter at the same time, so as to generate a determined result for indicating whether there are both the first physiological parameter and the second physiological parameter at the same time.

Optionally, in the case that the determined result indicates that there are both the first physiological parameter and the second physiological parameter at the same time, and the first execution instruction is a startup instruction or a function actuation instruction, the processor is adapted to:

execute the startup instruction to switch the glass-type electronic device from a power-off state to a startup state; or

execute the function actuation instruction to switch a 3D function of the glass-type electronic device from an off state to an on state.

Optionally, in the case that the determined result indicates that there are both the first physiological parameter and the second physiological parameter at the same time, the processor is further adapted to generate a third execution instruction to be executed by a first electronic device connected with the glass-type electronic device and adapted to switch the first electronic device from a third state to a fourth state, and in which the third state is different from the fourth state.

Optionally, the electronic device further includes a first communication interface, in which the first electronic device connected with the electronic device acquires a control instruction generated by the electronic device through the first communication interface, in the case that the electronic device is in the second state.

One or more of the above-mentioned technical solutions have at least the following technical effects or advantages.

By a technical means of providing a sensor at a position of a electronic device contacting with a head surface of a user, the following technical problems are solved: when an existing glass product is worn by the user, a function or state of the existing glass product can not be adjusted according to a requirement of the user or according to an environment automatically, and the existing glass product can not communicate with other device and control other devices. Therefore, technical effects of automation and intelligentization of the glass product can be achieved.

Furthermore, the appearance of the glass product looks tidier. In the application, the function of the glass product will be started up only when two or more sensors on the glass product are triggered. In other words, the glass product will not be started up when only one sensor on the glass product is triggered, so as to reduce a power consumption.

### BRIEF DESCRIPTION OF THE DRAWINGS

FIG. 1 is a flowchart of an information processing method according to a first embodiment of the application;

FIG. 2 is a schematic structural diagram of a glass-type electronic device according to the first and second embodiments of the application;

FIG. 3 is a systemic structural diagram of the glass-type electronic device according to the first and the second embodiments of the application; and

FIG. 4 is a systemic structural diagram of a Bluetooth headphone according to the first and second embodiments of the application.

### DETAILED DESCRIPTION OF THE INVENTION

Technical solutions of the invention will be described in detail by way of example in conjunction with the drawings hereinafter, so that those skilled in the art will understand the invention more clearly.

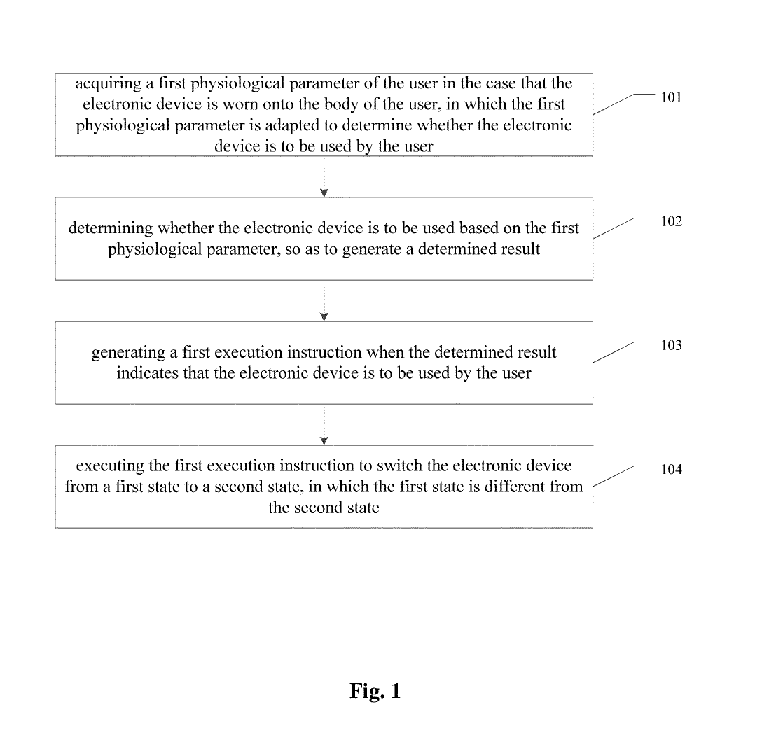

Referring to FIGS. 1, 2 and 3, an information processing method is provided according to a first embodiment of the invention, and the method is applied in an electronic device. The electronic device includes a structural component and a first sensor, the structural component is adapted to wear the electronic device onto a body of a user, and the first sensor is provided on the structural component and located at a first position of the structural component contacting with the body of the user. The method includes the following steps.

Step 101: acquiring a first physiological parameter of the user in the case that the electronic device is worn onto the body of the user, in which the first physiological parameter is adapted to determine whether the electronic device is to be used by the user.

In the implementation, the electronic device is a glass-type electronic device, and the structural component is a glass frame. The first sensor is provided at the first position which is located on a glass leg of the glass-type electronic device and can contact with the body of the user, i.e., a position of the glass leg contacting with an ear of the user. The number of the first sensor is at least one, e.g., one, two or three. The glass-type electronic device is an electronic glass device, such as a 3D glass, an electronic vision correction glass, a device in which color of a lens is adjusted by using an electronic technique, or a communication device. The glass-type electronic device is the 3D glass in the embodiment of the present application.

In the implementation, when the 3D glass is worn onto the body (e.g., a head) of the user, the ear of the user contacts with the first sensor. When the number of the first sensor is one, the first sensor will not be triggered to generate a signal; and when the number of the first sensor is two or more, the first sensor will be triggered to generate a signal. At this time, the first sensor detects a first physiological parameter of the user, e.g., a size and temperature of the ear, which is adapted to determine whether the user needs to use the 3D glass.

Step 102: determining whether the electronic device is to be used based on the first physiological parameter, so as to generate a determined result.

In the implementation, the 3D glass further includes a second sensor provided at a second position which is located at a nose pad of the glass frame of the 3D glass, i.e., a position contacting with the nose of the user. The number of the second sensor is at least one, e.g., one, two or three. A second physiological parameter of the user is acquired by the second sensor, e.g., a size and temperature of the nose and a height of the bridge of the nose.

In the implementation, when the 3D glass is worn onto the body of the user, e.g., the head of the user, the nose of the user contacts with the second sensor. When the number of the second sensor is one, the second sensor will not be triggered to generate a signal; and when the number of second sensor is two or more, the second sensor will be triggered to generate a signal. At this time, the second sensor detects a second physiological parameter of the user, e.g., a size and temperature of the nose and a height of the bridge of the nose.

In the implementation, the step of determining whether the electronic device is to be used by the user, so as to generate a determined result includes:

determining whether there are both the first physiological parameter and the second physiological parameter at the same time, so as to generate a determined result for indicating that there are both the first physiological parameter and the second physiological parameter at the same time.

The determined result is yes or no. If the determined result is yes, it indicates that there are both the first physiological parameter and the second physiological parameter at the same time; and if the determined result is no, it indicates that neither the first physiological parameter nor the second physiological parameter exists.

Step 103: generating a first execution instruction when the determined result indicates that the electronic device is to be used by the user.

In an implementation, if the determined result is yes, i.e., it indicates that there are both the first physiological parameter and the second physiological parameter at the same time, the determined result indicates that the electronic device, i.e., the 3D glass, is to be used by the user and then the first execution instruction is generated by the 3D glass, and the first execution instruction is a startup instruction or a function actuation instruction. The startup instruction is adapted to start up the 3D glass to bring the 3D glass into an operating state; and the function actuation instruction is adapted to actuate a specific function of the 3D glass, e.g., a 3D adjusting function.

Step 104: executing the first execution instruction to switch the electronic device from a first state to a second state, in which the first state is different from the second state.

In the implementation, the executing the first execution instruction, i.e., the startup instruction or the function actuation instruction, to switch the electronic device, i.e., the 3D glass, from the first state to the second state, includes:

executing the startup instruction to switch the 3D glass from a power-off state to a startup state; or

executing the function actuation instruction to switch the 3D function of the 3D glass from an off state to an on state.

The power-off state or the off state of the 3D function is the first state, and the startup state or the on state of the 3D function is the second state.

In addition, after the determining whether the electronic device is to be used by the user, the method further includes the following steps:

generating a second execution instruction in the case that the determined result indicates that the electronic device, i.e., the 3D glass, is to be used by the user; and

keeping the 3D glass in the first state according to the second execution instruction.

In the implementation, if the determined result is no, i.e., it indicates that neither the first physiological parameter nor the second physiological parameter exists, the electronic device will not be used by the user. In this case, the 3D glass generates the second execution instruction, e.g., an instruction to keep the 3D glass in the power-off state or keep a function of the 3D glass unchanged.

The second instruction is executed to keep the 3D glass in the first state, i.e., in the power-off state or a state in which the function of the 3D glass is kept.

In addition, after the determining whether the electronic device is to be used by the user so as to generate a determined result, the method further includes the following steps:

generating a third execution instruction to be executed by a first electronic device connected to the glass-type electronic device, i.e., the 3D glass, in the case that the determined result indicates that there are both the first physiological parameter and the second physiological parameter at the same time. The third execution instruction is adapted to switch the first electronic device from a third state to a fourth state. The third state is different from the fourth state.

In the implementation, if the determined result is yes, i.e., there are both the first physiological parameter and the second physiological parameter at the same time, it indicates that the user needs to use the 3D glass. In this case, the 3D glass generates the third execution instruction, e.g., the startup instruction or the function actuation instruction.

Based on the third instruction, e.g., the startup instruction or function actuation instruction, the first electronic device connected to the 3D glass will be switched from the power-off state to the startup state, or the 3D function of the first electronic device will be switched from the off state to the on state. The first electronic device includes a television, a computer, and a mobile phone etc. The first electronic device is the television in the embodiment of the present application.

A state where the television is powered off is the third state, and a state where the television is started up is the fourth state. Alternatively, a state where the 3D function of the television is off is the third state, and a state where the 3D function of the television is on is the fourth state.

In addition, the electronic device further includes a first communication interface, and the method further includes:

when the electronic device, i.e., the 3D glass, is in the second state, the first electronic device, i.e., the television, connected to the electronic device can acquire, through the first communication interface, a control instruction generated by the electronic device.

In the implementation, the first communication interface is provided on a lens of the 3D glass, and the lens further functions as a display. The user watches the television through the lens. When the 3D glass is in a startup state or a function actuation state, the instruction generated in the 3D glass is synchronized or consistent with the instruction acquired by the television connected to the 3D glass through the first communication interface. The television includes a first processor and a second communication interface. In the implementation, the television receives, through the second communication interface, the instruction transmitted through the first communication interface, and transmits the instruction to the first processor through the second communication interface. The first processor performs an operation corresponding to the instruction.

For example, when the user wears the 3D glass to watch a television in a room, the user can control the television by rotating an eyeball, such that the television can perform an operation as required by the user. When the user rotates the eyeball clockwise or anticlockwise, an execution instruction, e.g., to turn up or down a volume, will be generated in the 3D glass. The instruction is then transmitted to the second communication interface of the television through the first communication interface of the lens, and then transmitted to the first processor through the second communication interface. After receiving the instruction, the first processor performs, in response to the instruction, an operation corresponding to the instruction so as to turn up or down the volume.

In the implementation, when the user picks off the 3D glass, the television connected to the 3D glass exits the corresponding mode, i.e., the 3D mode.

In addition, the electronic device further includes a Bluetooth headphone. The situation where the electronic device is a Bluetooth headphone will be described in detail below.

For the above-mentioned step 101, in the implementation, the electronic device is the Bluetooth headphone, and the structural component is a headphone frame. The electronic device further includes a third sensor, which is provided at a third position on the headphone frame of the Bluetooth headphone and is enabled to contact with the body of the user, i.e., a position on the headphone frame contacting with the ear of the user. The third sensor can acquire the first physiological parameter of the user, such as the size and temperature of the ear, which is used to determine whether the user needs to use the Bluetooth headphone. In the implementation, the third sensor has the same function as that of the first sensor, which is adapted to acquire the first physiological parameter of the user, such as the size and temperature of the ear. The only difference between the third sensor and first sensor is that they are provided at different positions. Therefore, the first sensor of the 3D glass may further function as the third sensor of the Bluetooth headphone. The number of the third sensor is one.

In the implementation, when the user wears the Bluetooth headphone onto the body such as the head of the user, the ear of the user contacts with the third sensor, and the third sensor is triggered to generate a signal. At this time, the third sensor detects the first physiological parameter of the user, e.g., the size and temperature of the ear.

For the above-mentioned step 102, in the implementation, the step of determining whether the electronic device is to be used by the user so as to generate a determined result, includes:

determining whether there is the first physiological parameter to generate a determined result for indicating whether there is the first physiological parameter.

The determined result is yes or no. If the determined result is yes, it indicates that there is the first physiological parameter; and if the determined result is no, it indicates that there is not the first physiological parameter.

For the above-mentioned step 103, in the implementation, if the determined result is yes, i.e., it indicates that there is the first physiological parameter, the determined result indicates that the user needs to use the Bluetooth headphone. In this case, the first execution instruction is generated in the Bluetooth headphone, and the first execution instruction is the startup instruction or the function actuation instruction. The startup instruction is used to start up the Bluetooth headphone, so as to bring the Bluetooth headphone into an operating state. The function actuation instruction is used to actuate a specific function of the Bluetooth headphone, such as a music playing function.

For the above-mentioned step 104, in the implementation, the step of executing the first execution instruction, i.e., the startup instruction or the function actuation instruction, to switch the electronic device, i.e., the Bluetooth headphone, from the first state to the second state, includes:

executing the startup instruction to switch the Bluetooth headphone from the power-off state to the startup state; or

executing the function actuation instruction to switch the music playing function of the Bluetooth headphone from an off state to an on state.

The power-off state or the off state of the music playing function is the first state, and the startup state or the on state of the music playing function is the second state.

In addition, after the step of determining whether the electronic device, i.e., the Bluetooth headphone is to be used by the user, the method further includes the following steps:

generating the second execution instruction when the determined result indicates that the Bluetooth headphone is not to be used by the user; and

keeping the Bluetooth headphone in the first state according to the second execution instruction.

In the implementation, if the determined result is no, i.e., it indicates that there is not the first physiological parameter, the determined result indicates that the Bluetooth headphone is not to be used by the user. In this case, the second execution instruction, e.g., an instruction to keep the Bluetooth headphone in the power-off state or keep its function unchanged, is generated by the Bluetooth headphone.

The second execution instruction, e.g., an instruction to keep the Bluetooth headphone in the power-off state or keep its function unchanged, is executed so as to keep the Bluetooth headphone in the first state, i.e., the power-off state or a state where a function is kept unchanged.

In addition, after the step of determining whether the electronic device, i.e., the Bluetooth headphone is to be used by the user, so as to generate a determined result, the method further includes the following steps:

generating a third execution instruction to be executed by the first electronic device, i.e., the television, connected with the Bluetooth headphone when the determined result indicates that there is the first physiological parameter. The third execution instruction is adapted to switch the Bluetooth headphone from the third state to the fourth state, and the third state is different from the fourth state.

In the implementation, if the determined result is yes, i.e., there is the first physiological parameter, it indicates that the user needs to use the Bluetooth headphone. In this case, the third instruction, e.g., the startup instruction or the function actuation instruction, is generated by the Bluetooth headphone.

Based on the third instruction, e.g., the startup instruction or the function actuation instruction, the television connected with the Bluetooth headphone is switched from the power-off state to the startup state, or the music playing function of the television is switched from the off state to the on state.

The power-off state is the third state, and the startup state is the fourth state. Alternatively, the off state of the music playing function of the television is the third state, and the on state of the music playing function of the television is the fourth state.

In addition, the electronic device, i.e., the Bluetooth headphone, further includes a first communication interface, and the method further includes:

when the electronic device, i.e., the Bluetooth headphone, is in the second state, the first electronic device, i.e., the television, connected to the Bluetooth headphone acquires a control instruction generated by the Bluetooth headphone through the first communication interface.

In the implementation, the first communication interface is provided on the structural component, i.e., the headphone frame, of the Bluetooth headphone. When the Bluetooth headphone is in the startup state or the function actuation state, the instruction generated in the Bluetooth headphone is synchronized or consistent with the instruction acquired by the television connected to the Bluetooth headphone through the first communication interface. The television includes the first processor and the second communication interface. In the implementation, the television receives, through the second communication interface, the instruction transmitted by the first communication interface, and transmits the instruction to the first processor through the second communication interface. The first processor performs an operation corresponding to the instruction.

For example, when the user wears the Bluetooth headphone to watch the television, a noise sensor of the Bluetooth headphone can automatically detect a volume of music played by the television. When it is detected that the volume is relatively low, an instruction to turn up the volume is generated by the Bluetooth headphone. In this case, an adjustable loudspeaker provided in the Bluetooth headphone and connected with the noise sensor executes the instruction to turn up the volume, and the instruction is transmitted to the second communication interface on the television through the first communication interface of the headphone frame and then transmitted to the first processor through the second communication interface. After receiving the instruction, the first processor performs a corresponding operation, i.e., turning up the volume. In the implementation, the television can also turn down the volume through the first communication interface, and the description thereof is omitted.

In the implementation, when the user picks off or takes down the Bluetooth headphone, the television connected with the Bluetooth headphone also exits the corresponding mode. For example, when the Bluetooth headphone is taken down, the television also exits the music playing mode or turn off the music playing function.

In the implementation, similarly, the user also can wear the 3D glass along with the Bluetooth headphone, and control the television to which the 3D glass and the Bluetooth headphone are collectively connected. The description thereof is omitted.

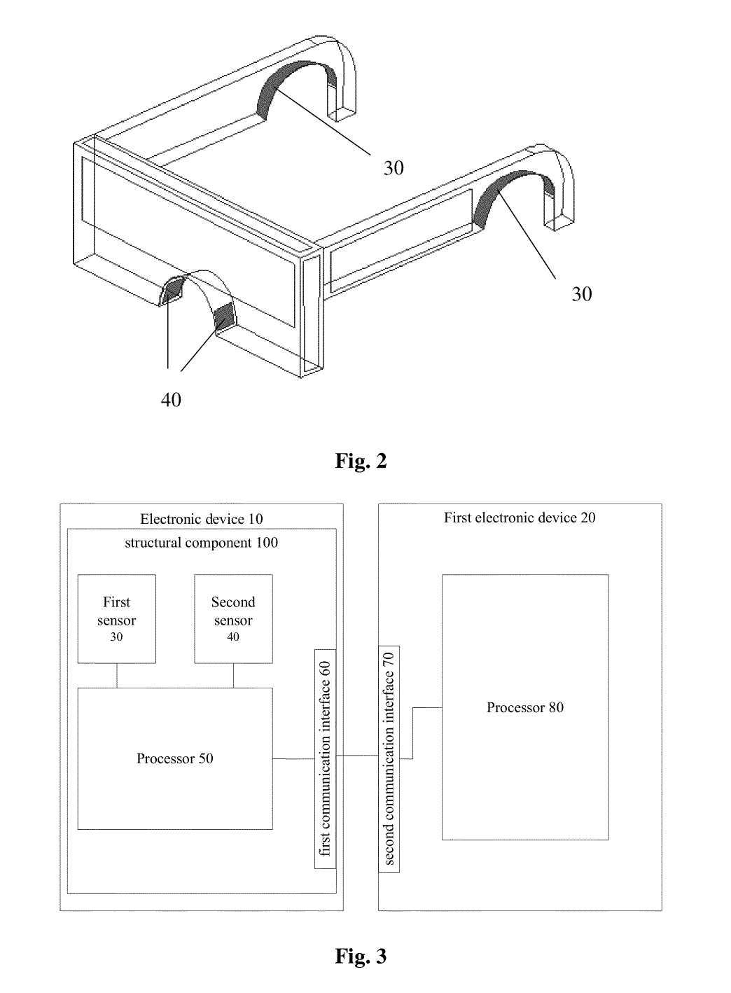

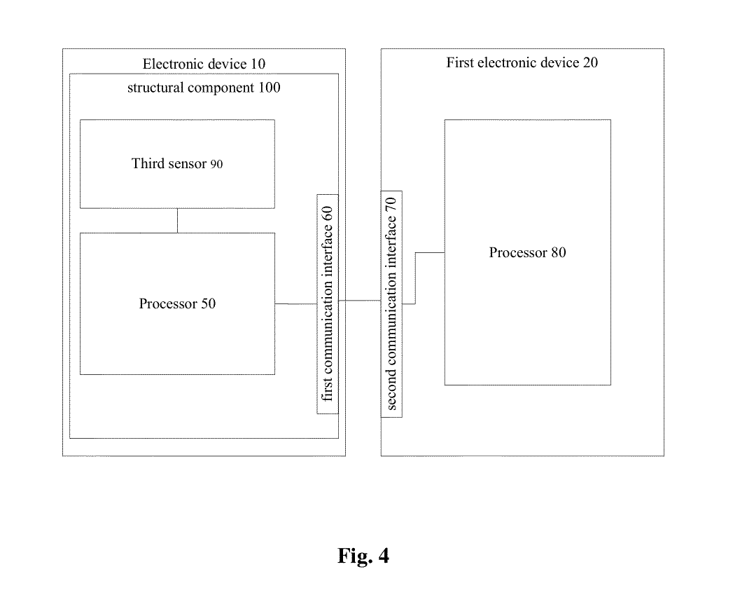

Referring to FIG. 2, FIG. 3 and FIG. 4, an electronic device according to a second embodiment of the present application includes:

a structural component 100 adapted to wear the electronic device onto a body of a user;

a first sensor 30 provided on the structural component 100 and located at a first position of the structural component 100 contacting with the body of the user, and adapted to acquire a first physiological parameter of the user corresponding to the electronic device;

a processor 50 connected with the first sensor 30, and adapted to receive the first physiological parameter, determine whether the electronic device is to be used by the user based on the first physiological parameter, and generate a first execution instruction in the case that the electronic device is to be used by the user, in which the first execution instruction is adapted to switch the electronic device from a first state to a second state, and the first state is different from the second state.

Specifically, the electronic device 10 is a glass-type electronic device or a Bluetooth headphone.

1. The electronic device 10 is the glass-type electronic device.

The electronic device 10 is the glass-type electronic device and the structural component included in the electronic device 10 is a glass frame. The first sensor 30 is provided at the first position of a glass leg of the glass-type electronic device contacting with the body of the user, i.e., a position of the glass leg contacting with an ear of the user. The number of the first sensor 30 is at least one, e.g., one, two or three. The glass-type electronic device is an electronic glass device, such as a 3D glass, an electronic vision correction glass, a device in which the color of the lens is adjusted by using an electronic technique, a communication device etc. The glass-type electronic device is the 3D glass in the embodiment of the application.

Specifically, when the user wears the 3D glass onto the body such as a head, an ear of the user contacts with the first sensor 30, and in the case that the number of the first sensor 30 is one, the first sensor 30 will not be triggered to generate a signal; in the case that the number of the first sensor 30 is two or more, the first sensor 30 will be triggered to generate a signal, and at this time, the sensor 30 detects the first physiological parameter of the user, e.g., a size and temperature of the ear, which is used to determine whether the 3D glass is to be used by the user.

2. The electronic device 10 is the Bluetooth headphone.

The electronic device is the Bluetooth headphone, and the structural component is a headphone frame. The electronic device further includes a third sensor 90, and the third sensor 90 is provided at a third position of the headphone frame of the Bluetooth headphone contacting with the body of the user, i.e., a position of the headphone frame contacting with the ear of the user. The third sensor 90 can acquire the first physiological parameter of the user, e.g., the size and temperature of the ear, which is used to determine whether the Bluetooth headphone is to be used by the user. In the application, the third sensor 90 has the same function as the first sensor 30, which is used to acquire the first physiological parameter of the user, e.g., the size and temperature of the ear. The only difference between the first sensor 30 and third sensor 90 is that they are provided at different positions. Therefore, the first sensor 30 of the 3D glass may also function as the third sensor 90 of the Bluetooth headphone, and the number of third sensor is one.

Specifically, when the user wears the Bluetooth headphone onto the body such as the head, the ear of the user contacts with the third sensor, and the third sensor is triggered to generate a signal. In this case, the third sensor detects the physiological parameter of the user, e.g., the size and temperature of the ear.

The processor 50 is further adapted to generate a second execution instruction for keeping the electronic device 10 in the first state, in the case that the electronic device 10 is not to be used by the user.

Specifically, when the electronic device 10 is the glass-type electronic device, the electronic device 10 further includes:

a second sensor 40 provided at a second position which is located at a nose pad of a glass frame of the glass-type electronic device, and adapted to acquire a second physiological parameter of the user.

The processor 50 is further adapted to determine whether there are both the first physiological parameter and the second physiological parameter at the same time, so as to generate a determined result for indicating whether there are both the first physiological parameter and the second physiological parameter at the same time.

When the determined result indicates that there are both the first physiological parameter and the second physiological parameter at the same time, and the first execution instruction is a startup instruction or a function actuation instruction, the processor 50 is adapted to:

execute the startup instruction to switch the glass-type electronic device from a power-off state to a startup state; or

execute the function actuation instruction to switch a 3D function of the glass-type electronic device from an off state to an on state.

The processor 50 is further adapted to determine that there are both the first physiological parameter and the second physiological parameter at the same time, so as to generate a third execution instruction to be executed by a first electronic device 20 connected with the glass-type electronic device. The third execution instruction is used to switch the first electronic device 20 from a third state to a fourth state, and the third state is different from the fourth state.

In addition, the electronic device 10 further includes a first communication interface 60. When the electronic device 10 is in the second state, the first electronic device 20 connected with the electronic device 10 can acquire, through the first communication interface 60, a control instruction generated by the electronic device 10. The electronic device 10 is the glass-type electronic device or the Bluetooth headphone. The first electronic device 20 includes a first processor 80 and a second communication interface 70. In the implementation, the first electronic device 20 receives, through the second communication interface 70, the instruction transmitted by the first communication interface 60, and transmits the instruction to the first processor 80 through the second communication interface 70. The first processor 80 performs an operation corresponding to the instruction.

Specifically, when the user picks off or takes down the 3D glass or the Bluetooth headphone, or picks off or takes down both the 3D glass and the Bluetooth headphone, the first electronic device 20 connected to the 3D glass or the Bluetooth headphone exits the corresponding mode, e.g., when the Bluetooth headphone is picked off, the first electronic device 20 exits the music playing mode or turns off the music playing function.

One or more of the technical solutions according to an embodiment of the invention have at least the following technical effects.

By adopting a technical solution of providing a sensor at a position of an electronic device contacting with a body of a user, the following technical problems are solved: when an existing glass product is worn by the user, a function or a state thereof can not be adjusted according to a requirement of the user or according to an environment automatically, and the existing glass product can not control and communicate with other devices. Therefore, the technical effect of automation and intelligentization of the glass product can be obtained.

Furthermore, the appearance of the glass product looks more tidy. In the application, the glass product will be started up only when two or more sensors of the glass product are triggered. In other words, the glass product will not be started up when only one sensor on the glass product is triggered. Therefore, a technical effect of reduced power consumption can be obtained.

Apparently, various modifications and variants can be made to the invention by those skilled in the art without departing from the spirit and scope of the invention. Therefore, when those modifications and variants of the invention fall within the scope of the claims and equivalents thereof, the invention also intends to include those modifications and variants.

1. An information processing method applied to an electronic device, wherein the electronic device comprises a structural component and a first sensor, the structural component is adapted to wear the electronic device onto a body of a user, and the first sensor is provided on the structural component and located at a first position of the structural component contacting with the body of the user, wherein the method comprises:
acquiring a first physiological parameter of the user by the first sensor in the case that the electronic device is worn onto the body of the user, wherein the first physiological parameter is adapted to determine whether the electronic device is to be used by the user;
determining whether the electronic device is to be used by the user based on the first physiological parameter, so as to generate a determined result;
generating a first execution instruction in the case that the determined result indicates that the electronic device is to be used by the user; and
executing the first execution instruction to switch the electronic device from a first state to a second state, wherein the first state is different from the second state.

2. The method according to claim 1, wherein after the determining whether the electronic device is to be used by the user, the method further comprises:
generating a second execution instruction in the case that the determined result indicates that the electronic device is not to be used by the user; and
keeping the electronic device in the first state according to the second execution instruction.

3. The method according to claim 1, wherein the electronic device is a glass-type electronic device and the structural component is a glass frame.

4. The method according to claim 3, wherein the electronic device further comprises a second sensor, which is provided at a second position which is located at a nose pad of the glass frame of the glass-type electronic device; and the first sensor is provided at the first position which is located at a glass leg of the glass-type electronic device and contacts with the body of the user.

5. The method according to claim 4, further comprising:
acquiring a second physiological parameter of the user by the second sensor.

6. The method according to claim 5, wherein the determining whether the electronic device is to be used by the user, so as to generate a determined result further comprises:
determining whether there are both the first physiological parameter and the second physiological parameter at the same time, so as to generate the determined result for indicating whether there are both the first physiological parameter and the second physiological parameter at the same time.

7. The method according to claim 6, wherein in the case that the determined result indicates that there are both the first physiological parameter and the second physiological parameter at the same time, the first execution instruction comprises a startup instruction or a function actuation instruction, and the executing the first execution instruction to switch the electronic device from the first state to the second state comprises:
executing the startup instruction to switch the glass-type electronic device from a power-off state to a startup state; or
executing the function actuation instruction to switch a 3D function of the glass-type electronic device from an off state to an on state.

8. The method according to claim 5, wherein after the determining whether the electronic device is to be used by the user, so as to generate a determined result, the method further comprises:
generating a third execution instruction, in the case that the determined result indicates that there are the first physiological parameter and the second physiological parameter at the same time, wherein the third execution instruction is executed by the first electronic device connected with the glass-type electronic device and is adapted to switch the first electronic device from a third state to a fourth state, and the third state is different from the fourth state.

9. The method according to claim 1, wherein the electronic device further comprises a Bluetooth headphone and the structural component is a headphone frame.

10. The method according to claim 9, wherein the electronic device further comprises a third sensor provided at a third position of the Bluetooth headphone contacting with the body of the user.

11. An electronic device, comprising:
a structural component adapted to wear the electronic device onto a body of a user;
a first sensor provided on the structural component and located at a first position of the structural component contacting with the body of the user, and adapted to acquire a first physiological parameter of the user corresponding to the electronic device; and
a processor connected with the first sensor, and adapted to receive the first physiological parameter, determine whether the electronic device is to be used by the user based on the first physiological parameter, and generate a first execution instruction in the case that the electronic device is to be used by the user, wherein the first execution instruction is adapted to switch the electronic device from a first state to a second state, and the first state is different from the second state.

12. The electronic device according to claim 11, wherein the processor is further adapted to generate a second execution instruction in the case that the electronic device is to be used by the user, and the second execution instruction is adapted to keep the electronic device in the first state.

13. The electronic device according to claim 11, wherein the electronic device is a glass-type electronic device and the structural component is a glass frame.

14. The electronic device according to claim 13, further comprising:
a second sensor provided at a second position which is located at a nose pad of the glass frame of the glass-type electronic device, and adapted to acquire a second physiological parameter of the user.

15. The electronic device according to claim 14, wherein the electronic device further comprises a Bluetooth headphone, and the structural component is a headphone frame.

16. The electronic device according to claim 14, wherein the electronic device further comprises a third sensor provided at a third position of the Bluetooth headphone contacting with the body of the user.

17. The electronic device according to claim 11, wherein the processor is further adapted to determine whether there are both the first physiological parameter and the second physiological parameter at the same time, so as to generate a determined result for indicating whether there are both the first physiological parameter and the second physiological parameter at the same time.

18. The electronic device according to claim 17, wherein in the case that the determined result indicates that there are both the first physiological parameter and the second physiological parameter at the same time, and the first execution instruction is a startup instruction or a function actuation instruction, the processor is adapted to:
execute the startup instruction to switch the glass-type electronic device from a power-off state to a startup state; or
execute the function actuation instruction to switch a 3D function of the glass-type electronic device from an off state to an on state.

19. The electronic device according to claim 11, wherein in the case that the determined result indicates that there are both the first physiological parameter and the second physiological parameter at the same time; the processor is further adapted to generate a third execution instruction to be executed by a first electronic device connected with the glass-type electronic device, and wherein the third execution instruction is adapted to switch the first electronic device from a third state to a fourth state, and the third state is different from the fourth state.

20. The electronic device according to claim 11, further comprising a first communication interface, wherein the first electronic device connected with the electronic device acquires a control instruction generated by the electronic device through the first communication interface, in the case that the electronic device is in the second state.
